(19) United States
(12) Patent Application Publication
(10) Pub. No.: US 2026/0004261 A1
(43) Pub. Date: Jan. 1, 2026

(54) SYSTEM FOR FACILITATING CRYPTOGRAPHIC TOKEN TRANSACTIONS

(71) Applicant: IGT, Las Vegas, NV (US)

(72) Inventors: Bethany PLIMMER, Lower Coverdale (CA); Aaron COREY, Moncton (CA); Jackie ALVAREZ, Las Vegas, NV (US); Fayez IDRIS, Dieppe (CA); David FROY, Lakeville-Westmorland (CA); David SMALL, Moncton (CA); Karen VAN NIEKERK, Dieppe (CA); Gaurav JARIWALA, Halifax (CA); Todd GRIMM, Riverview (CA); Daniel LANDRY, Moncton (CA)

(73) Assignee: IGT, Las Vegas, NV (US)

(21) Appl. No.: 18/754,297

(22) Filed: Jun. 26, 2024

(51) Int. Cl. G06Q 20/06; G06Q 30/08; G07F 17/32

(52) U.S. Cl. CPC G06Q 20/065; G06Q 30/08; G07F 17/3244; G06Q 2220/00

(57) ABSTRACT

A system displays a marketplace interface at a display device comprising a plurality of cryptographic tokens, each cryptographic token comprising an acquisition price and a seller identifier associated with a seller of the cryptographic token, the acquisition price including a sale price. A token selection of a first cryptographic token of the plurality of cryptographic tokens is received from a purchaser. The acquisition price associated with the first cryptographic token is received from the purchaser, the first cryptographic token is provided to the purchaser, and the sale price is provided to the seller.

### BACKGROUND

Embodiments described herein relate to cryptographic tokens for use with wagering games, and in particular to a system for facilitating cryptographic token transactions in a gaming environment, such as in a casino environment, and related devices, systems, and methods. As the use of cryptographic tokens becomes more widespread, it may be difficult for users to execute transactions using the cryptographic tokens without specialized knowledge and skills relating to blockchain technology. There is a need for a system for facilitating cryptographic token transactions that is more accessible to the general public.

### BRIEF SUMMARY

According to some embodiments, a system includes a processor circuit and a memory coupled to the processor circuit. The memory includes machine-readable instructions that, when executed by the processor circuit, cause the processor circuit to display a marketplace interface at a display device comprising a plurality of cryptographic tokens, each cryptographic token comprising an acquisition price and a seller identifier associated with a seller of the cryptographic token, the acquisition price comprising a sale price. The instructions further cause the processor circuit to receive a token selection of a first cryptographic token of the plurality of cryptographic tokens from a purchaser. The instructions further cause the processor circuit to receive the acquisition price associated with the first cryptographic token from the purchaser. The instructions further cause the processor circuit to provide the first cryptographic token to the purchaser. The instructions further cause the processor circuit to provide the sale price to the seller.

According to some embodiments, a token management device includes a display device, an input device, a processor circuit, and a memory comprising machine readable instructions. When executed by the processor circuit, the instructions cause the processor circuit to display a marketplace interface at the display device comprising a plurality of cryptographic tokens, each cryptographic token comprising an acquisition price and a seller identifier associated with a seller of the cryptographic token, the acquisition price comprising a sale price. The instructions further cause the processor circuit to receive, via the input device, a token selection of a first cryptographic token of the plurality of cryptographic tokens from a purchaser. The instructions further cause the processor circuit to receive the acquisition price associated with the first cryptographic token from the purchaser. The instructions further cause the processor circuit to provide the first cryptographic token to the purchaser. The instructions further cause the processor circuit to provide the sale price to the seller.

According to some embodiments, a method includes displaying, by a display device of a token management device, a marketplace interface at the display device comprising a plurality of cryptographic tokens, each cryptographic token comprising an acquisition price and a seller identifier associated with a seller of the cryptographic token, the acquisition price comprising a sale price. The method further includes receiving, via an input device, a token selection of a first cryptographic token of the plurality of cryptographic tokens from a purchaser. The method further includes receiving, by the token management device, the acquisition price associated with the first cryptographic token from the purchaser. The method further includes providing, by the token management device, the first cryptographic token to the purchaser. The method further includes providing, via a communication interface of the token management device, the sale price to the seller.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic block diagram illustrating various operations for a blockchain token transaction according to some embodiments.

FIGS. 4A and 4B illustrate a graphical marketplace interface for providing cryptographic token marketplace at a kiosk device, according to some embodiments.

FIG. 5 illustrates the graphical marketplace interface for facilitating an auction transaction, according to some embodiments.

FIG. 6 illustrates the graphical marketplace interface for redemption of a cryptographic token, according to some embodiments.

FIG. 7 is a flowchart illustrating operations of systems/methods of facilitating cryptographic token transactions in a token marketplace, according to some embodiments.

### DETAILED DESCRIPTION

Embodiments described herein relate to cryptographic tokens for use with wagering games, and in particular to a system for facilitating cryptographic token transactions in a gaming environment, such as in a casino environment, and related devices, systems, and methods. In some examples, an online marketplace may allow players to purchase, sell, redeem, upgrade or trade tokens (e.g., fungible, non-fungible, and/or semi-fungible tokens) associated with gaming. The marketplace may be a service accessible to players from any gaming jurisdiction, or it could be segmented by jurisdiction, by customer (e.g., by casino, or lottery). The marketplace may be provided as a cloud service operated by a third party or provided as a turn-key product to a gaming customer or other third-party operator.

In some examples, players can own tokens that are awarded, redeemed, or used in some manner in connection with their gaming activities. In these examples, a marketplace may enhance the real or perceived value of the tokens by allowing players to engage in a variety of transactions with them. These transactions can be financial, or they can be non-financial. In this manner, players may sell or redeem owned tokens to obtain a financial or other benefit from them outside of direct use of the tokens in gaming, while other players may purchase tokens directly without having to earn or win them in a game, i.e., paying to take a shortcut in acquiring the tokens. The marketplace may also provide the player the ability to modify their tokens so that they are more valuable, powerful, or special in some way. The added value in the upgraded token could be purely subjective or it could be something more tangible. For example, an upgraded token might have a more pleasing appearance, or it might feel more personalized or unique. An example of a more tangible upgrade may enhance the in-game capabilities of the token, such as giving the player some sort of advantage with their game play (e.g., unlocking game feature, unlocking better pay tables, etc.). The marketplace may also allow the player to trade tokens with other players or with the operator/owner of the marketplace itself, e.g., to exchange existing tokens for other tokens they consider to be more desirable (i.e., greater value, greater aesthetics, greater collectability, etc.).

Different players may value different characteristics of the tokens. For example, some players may be interested in completing a set of related tokens, the appearance or rarity of certain tokens, and/or tokens that are connected with certain games or that have certain in-game capabilities, etc. The ability to trade tokens can increase player satisfaction by giving players alternative ways of obtaining tokens that are more pleasing or valuable to them on a personal level.

In some examples, the marketplace may offer players the ability to exchange tokens, so they are not tied to one particular ecosystem, such as cryptocurrency, other gaming vendor tokens, other gaming jurisdictions, etc. In this manner, a mutually beneficial relationship could be established between the various token ecosystems that encourages the overall growth of tokens in gaming.

The marketplace may be enabled by various technologies, including an e-commerce solution, a player-facing interface of the marketplace for the Internet or other networked computing devices, accounting and invoicing, i.e., for logging all transactions for traceability, flagging suspicious transactions and other anti-money laundering features, and/or tracking royalties and fees for the system operator and other parties involved in a revenue-sharing relationship with the marketplace, etc. Other features may enable tracking of native tokens, i.e., tokens created within a particular ecosystem, and foreign tokens, i.e., tokens created in another ecosystem.

In some examples, the marketplace may manage buying, selling, trading transactions, exchange rates for foreign tokens (which may be linked to an external third-party system for example), managing merchandise available via token redemption, buyer and seller ranking system, feedback features, commercial profiles for buyers and sellers. The marketplace may include messaging features, such as private messages from other players, messages and notifications from system operators, etc., and may include player configurable watch-lists for tokens that different players want to buy, sell, trade, etc.

The marketplace may track and store player token and transaction history, such as purchases, sales, trades, upgrades, and/or customizations. The marketplace may include mechanisms for flagging tokens with certain criteria, a verification and/or certification feature for verifying authenticity and/or accurate descriptions of pre-owned tokens, which may help to prevent fraud and encourage player confidence in the token marketplace. The marketplace may include refund/rollback capability for fraudulent and/or improper transfers.

The marketplace may include player account management features, such as linking ownership of tokens to players, player's gaming preferences, history of game-related token activities, including tokens spent, used, awarded, earned, etc. A token minting mechanism may mint new tokens based on different criteria, with minting fees that can be charged to the player when purchasing new tokens. In some examples, fractions of a token may be deducted and/or recycled as part of a transaction. Complete tokens may also be recycled after they are consumed, used, and/or spent by the player, such as for gaming activities or features. In this manner, new minting activity and associated costs may be reduced.

The marketplace may include and/or communicate with a player tracking system, which may enable a player to access the marketplace while playing at a casino gaming device, such as an Electronic Gaming Machine (EGM). The marketplace may also be available on the Internet, through a player tracking interface, or other interfaces. In some examples, a marketplace interface may allow players to see their transaction history (such as tokens purchased, sold, traded, earned/awarded, spent, upgraded, etc.) and to be notified of potential trades based on certain criteria, such as the player including a token on a watch list.

Different token ecosystems may be based on different regulatory, political, and/or economic considerations. Each token ecosystem may include a self-contained virtual or physical system within which tokens are created, bought, sold, spent, consumed and/or modified. For example, different operators may want their own separate token ecosystem for competitive or commercial reasons, such as competitive advantage, custom branding, custom rules/restrictions, custom promotions and other features, to avoid commercial entanglements with other customers, etc.

In some examples the marketplace could be operated as a paid cloud service, with system operator fees charged to customers for a custom-branded solution (such as a flat recurring fee or percentage of revenue from fees/royalties on players' token transactions). In some examples, the marketplace may be a standalone product operated by a customer or other third-party operator, which may be required by some jurisdictions for regulatory reasons (i.e., having all gaming-related operations physically located in a particular jurisdiction), or commercial reasons, such as preferring a one-time capital expenditure to recurring fees.

In some examples, foreign tokens may include general cryptocurrency (e.g., Bitcoin, Ethereum, etc.), tokens from other gaming vendors/ecosystems, such as via mutual agreement with an exchange rate for the different tokens. Fees and/or royalties may be collected for monetary transactions, buying, selling, or upgrading tokens where actual currency is involved in the transactions, minting fees, etc. Virtual fees on non-monetary transactions may be deducted to offset minting costs, such as reducing the token's value by a predetermined percentage, and/or by removing features, in-game capabilities, number of available redemptions, acceleration of an expiration date or time, etc. If the transaction involves more than two tokens being exchanged during the transaction, one or more tokens could be deducted from the total as a fee. Alternatively, the marketplace could prompt the players to select additional tokens (of a specified value) from their accounts to cover the trading fees. Tokens that are consumed or spent by the player (or fractions of tokens traded by the player) may be recycled/reused when new tokens need to be minted. Since minting new tokens can be a costly or energy-inefficient process, the ability to reuse existing tokens or fractions of tokens may be used to reduce the overall cost of creating new tokens. For example, the recycled tokens could be used directly as “new” tokens, e.g., similar to a coin being put back into circulation. In some examples, the minting process may be configured to accept recycled tokens as inputs, thereby reducing the time and/or resources consumed during the minting of new tokens.

In some examples, tokens may be upgraded and/or customized via the marketplace. For example, for fungible or semi-fungible tokens, the player can transform their token in some way, such as by redeeming other tokens or by paying with currency, thereby producing a semi-fungible or non-fungible token. In some examples, tokens may be combined to create a new, more valuable token, which may have the combined characteristics from the tokens being combined. In some examples, a portion of the value, characteristics, or capabilities of the original tokens could be deducted as a virtual transaction fee, such that the resulting token may be more valuable than one of the original tokens, but less than the combined value of the combined tokens. Upgrades for tokens may include greater monetary value, greater in-game functionality, enhanced appearance and/or aesthetics, higher rarity, personalization, etc.

Redemption of tokens in the marketplace may include the player trading a token for a non-monetary item, such as merchandise, free play vouchers, scratch tickets, or other items. In some examples, the player may be presented with a list of available prizes and may be allowed to select one or more prizes based on the value of the token and the value of the prizes. The token may not necessarily be tied to one specific prize, such that the player can choose one or more prizes from a list of available prizes. The total value of the prize(s) selected by the player for redemption may be less than or equal to the value of the NFT being redeemed.

Each prize available to players in the marketplace may have a value assigned to it (e.g., a number of points, units of currency, etc.). The value of each prize may be chosen by the operator of the marketplace based on the actual cost of the prize or some other criteria determined by the operator. Each token may also have a specific value associated with it (e.g., a number of points, units of currency, etc.). The value assigned to each token may be determined by the logic of the game that awarded to token to the player (e.g., a value based on the type of game win or event) or by some other method outside of the marketplace.

In some examples, a player may set up a personal storefront for token transactions within the marketplace. The storefront may be personalized, e.g., with a player's customized logo and/or theme. Some designated player may offer other token-related services such as customizing or upgrading tokens. These players may be selected by the marketplace provider in some examples. In some examples, storefront owners can invite, designate, and reward players with branded/themed badges or accessories that could be applied to their tokens (e.g., as a customization or upgrade to the tokens). For example, upgrades may be achievement based (e.g., attending a specified number of events to then have access to another event), rewards for players who sponsor (e.g., with money) live game play events, in-person attendance at specific events, etc. In some examples, upgrades may allow the token to be used for admission and/or access to events and/or content. Further upgrades may include discounts on events or merchandise, and/or other rewards that may add perceived value for both parties in the transaction. For example, the designated users may receive more followers (because players want the benefits of the upgraded tokens) and other players may receive exclusive rewards.

In some examples, the marketplace may include services related to physical tokens. For example, physical versions of electronic tokens may be 3D printed and provided to the player. The marketplace may also provide a mechanism to store a physical token on behalf of the players as a service. For example, a player could receive a certificate representing the token as proof of ownership. In some examples, physical tokens could contain embedded digital storage to function as a hardware wallet (e.g., a stylized token-shaped device that contains the player's collection of digital tokens). The marketplace may also include decorative display cases where players can store/display their physical tokens, which may be branded according to a game theme (e.g., a themed display case to display the tokens related to a specific game), trading cards and stickers related to the tokens, or other items. These and other items may be custom printed with identifying information for verifying authenticity.

In some examples, the marketplace may notify players when certain tokens become available. For example, if a player is missing a token from a collection of related tokens and another player has extra/duplicate tokens that match the missing token, the marketplace may automatically notify the players to facilitate a quick trade. Players may configure and/or select what tokens they are interested in acquiring or trading away, and the marketplace may then automatically monitor and/or search the available tokens to find matches.

In some examples, tokens may be advertised directly through gaming devices, such as EGMs. In some examples, advertisements could be provided as a general broadcast to all players to promote a new game, and/or based on the game currently being played (e.g., token could be related to the game being played, a newer game in the same series or a similar game theme). In some examples, advertisements may be based on observations of the player's behavior or play history, e.g., inferring what tokens they might be interested in based on a variety of factors, such game preferences, previously collected tokens, etc.

In some examples, transaction fee may be collected by different parties, such as a marketplace provider and/or operator. Fees may be based on a number of factors, such as values of sold or traded tokens, an overall trade value, etc. In some examples, fractional values of tokens may be reduced, with the fee deduction reintroduced into a pool of unused tokens to reduce the amount of new minting and/or to be used as a proof-of-stake for future minting.

In some examples, an independent third party may manage or mediate token exchanges between ecosystems/sources, e.g., between different casino operators, between gaming suppliers, between gaming jurisdictions, and/or between market segments (e.g., casino, VLT, lottery, sports betting, etc.). An independent third party may manage the exchange rates and fees, so they are determined objectively (without any real or perceived bias). Agreements between the owners and/or regulators of the ecosystems involved may take into account and reconcile any regulatory, political, or commercial implications of exchanging the tokens between ecosystems. Additional transaction fees for handling these types of transactions may be imposed due to the added complexity and the need for the independent exchange to cover costs and/or profit from this activity.

In some examples, each ecosystem may have its own list of other ecosystems with which tokens can be exchanged, with tokens from ecosystems not in the list being ineligible for exchange. Token exchange rates may be specific to each ecosystem, and may be independent any technical similarity of the ecosystems involved in the exchange, such as by agreement between the parties.

In some examples, the marketplace may facilitate auction transactions, to allow players to make token available to buy through a bidding process. In some examples, an auction may be bypassed by a player paying a predetermined purchase price. Auctions may be configurable, with configurable parameters including time limits, minimum bids, transaction types (e.g., cash or token), and other parameters.

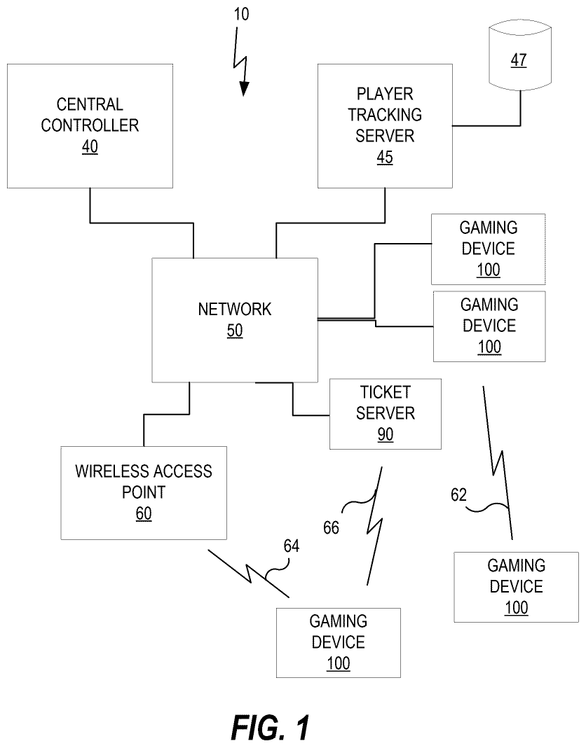

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

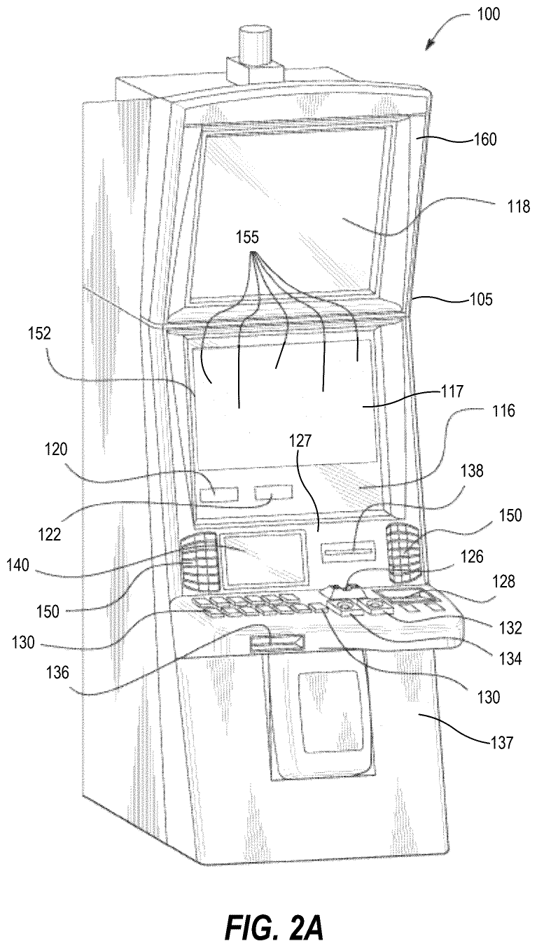

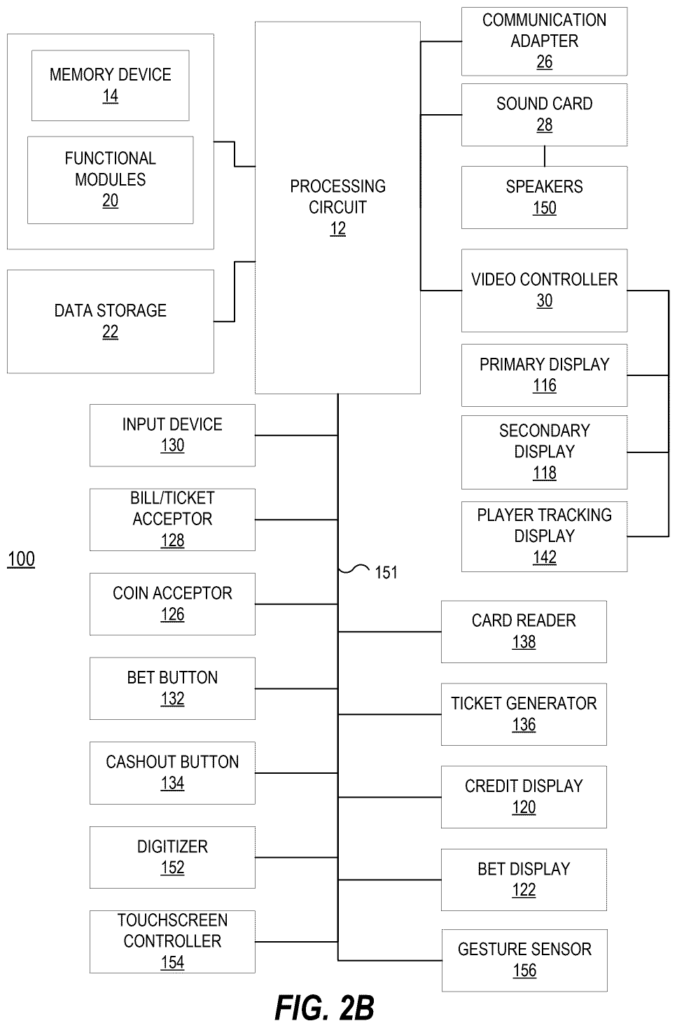

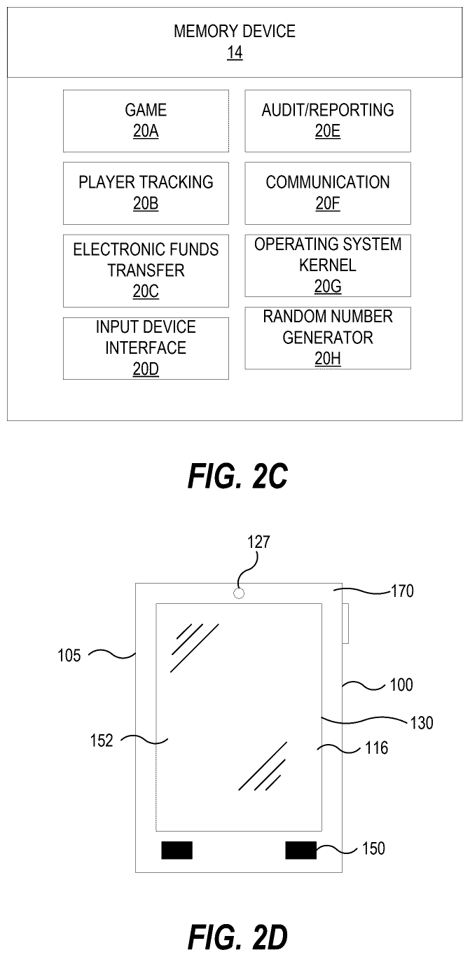

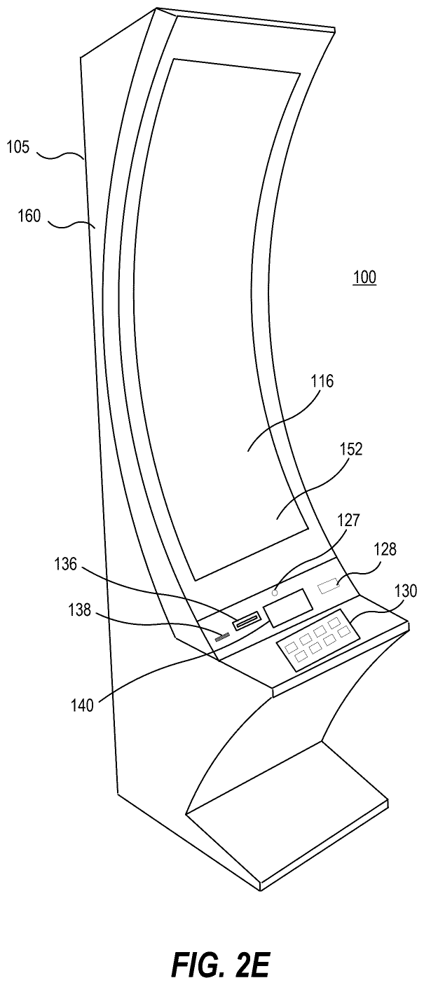

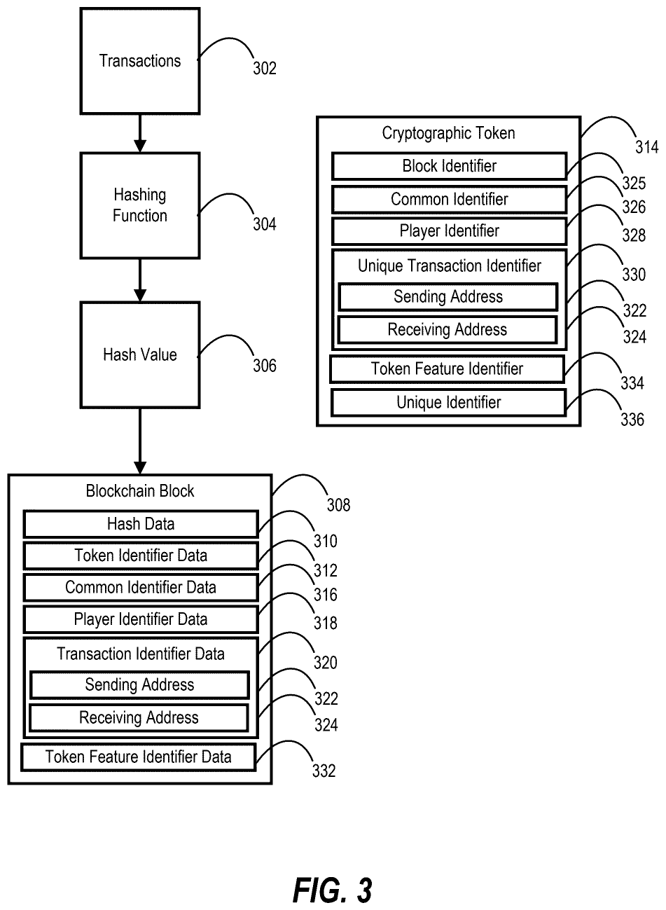

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

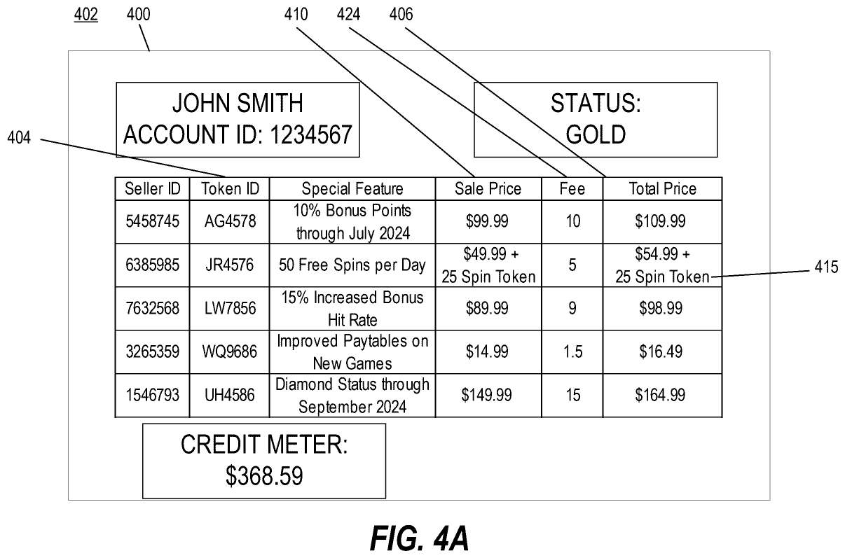

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include token feature identifier data 332 associated with a token feature, such as an in-game feature or benefit, associated with the cryptographic token 314. Alternatively or in addition, the cryptographic token 314 may include a token feature identifier 334 corresponding to the feature and/or token feature identifier data 332. Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (POS) consensus algorithm, which may be used as the value of an underlying data block and/or value changes.

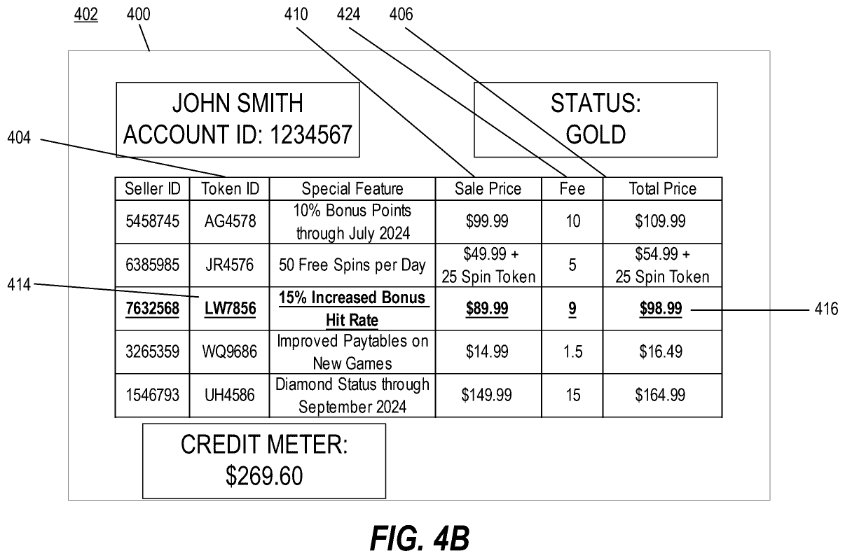

Referring now to FIGS. 4A and 4B, a graphical marketplace interface 400 is illustrated for providing cryptographic token marketplace at a kiosk device 402, according to some embodiments. As shown by FIG. 4A, the interface 400 may include a plurality of cryptographic tokens 404, with each cryptographic token 404 including an acquisition price 406 and a seller identifier 408 associated with a seller of the cryptographic token 404. Each acquisition price 406 in this example includes a sale price 410 and may also include a transaction fee 424, which is a difference between the acquisition price 406 and the sale price 410 in this example. In some examples, an acquisition price 406 associated with one or more of the cryptographic tokens 404 may include a different cryptographic token 415 associated with the purchaser, e.g., as part of a trade and/or trade/purchase transaction.

As shown by FIG. 4B, a token selection 412 may be received from a purchaser via the marketplace interface 400 for a first cryptographic token 414 of the plurality of cryptographic tokens 404. The selection 412 may automatically initiate receipt of the acquisition price 416 of the first cryptographic token 414 from the purchaser and provision of the first cryptographic token 414 to the purchaser. In some examples, provision of the first cryptographic token 414 to the purchaser may include receipt of the first cryptographic token 414 from the seller, modification of the first cryptographic token 414 to reduce a token value of the first cryptographic token 414, and provision of the modified first cryptographic token 414 to the purchaser.

The sale price 418 portion of the acquisition price 416 of the first cryptographic token 414 may be provided to the seller. In some examples, provision of the sale price 418 to the seller may include retention of the transaction fee 424. In some examples, such as where a second cryptographic token 415 is provided as part of the acquisition price 416, the second cryptographic token 415 may be modified to reduce a token value of the second cryptographic token 415. In some examples, the seller may include comprises a first gaming operator, such as a first casino operator (e.g., associated with a first gaming channel), and the purchaser may include a second gaming operator, such as a second casino operator (e.g., associated with a different gaming channel).

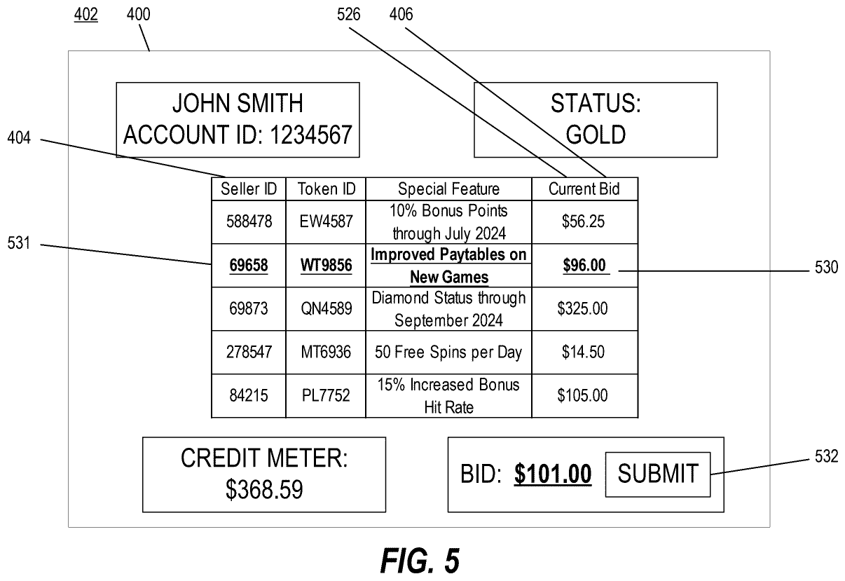

Referring now to FIG. 5, the graphical marketplace interface 400 is further configured for facilitating an auction transaction, according to some embodiments. In this example, an acquisition price 406 for a cryptographic token may be determined by a plurality of auction bids 526 by a plurality of bidders, such that a first bidder associated with a highest auction bid 530 of the plurality of auction bids becomes the purchaser. For example, the buyer may enter a new bid 532 for a selected token 531 to attempt to become the high bidder for the selected token 531.

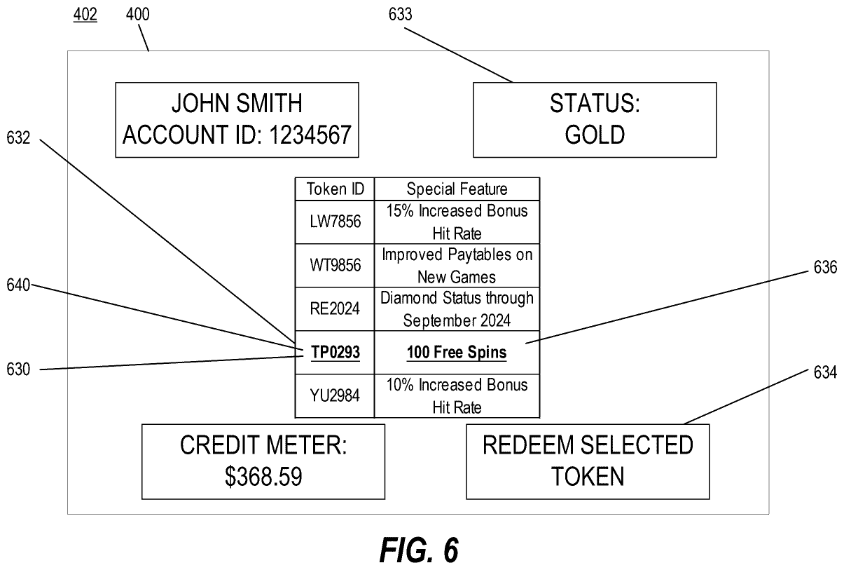

Referring now to FIG. 6, the graphical marketplace interface 400 is further configured for redemption of a cryptographic token 632, according to some embodiments. In this example, a token redemption request 634 by a user is received, and a token identifier 630 for the cryptographic token 632 is determined. A non-monetary token value for the cryptographic token 632 may be determined and, based on the non-monetary token value, the associated non-monetary award 638 may be displayed by the interface 400 and awarded to the player. In some examples, each available non-monetary award 638 may include a value equal to or less than a non-monetary token value for the token 632. In some examples, the non-monetary token value is based on game play by a player associated with the token 632, based on a player status 633 of a player associated with the token 632, and/or based on any number of other criteria, as desired. In response to receipt from the user of a selection 640 of a non-monetary award 638, the selected non-monetary award 642 is provided to the user.

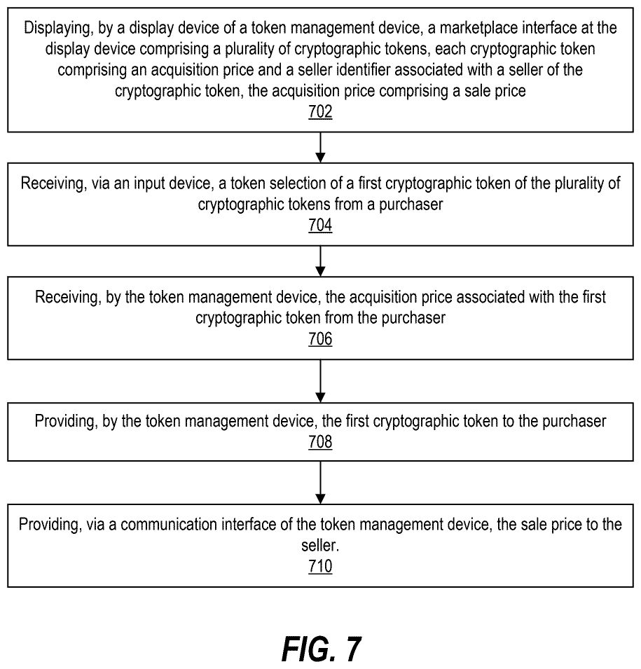

FIG. 7 is a flowchart illustrating operations 700 of systems/methods of facilitating cryptographic token transactions in a token marketplace, according to some embodiments. The operations 700 may include displaying, by a display device of a token management device, a marketplace interface at the display device comprising a plurality of cryptographic tokens, each cryptographic token comprising an acquisition price and a seller identifier associated with a seller of the cryptographic token, the acquisition price comprising a sale price (Block 702).

The operations 700 may further include receiving, via an input device, a token selection of a first cryptographic token of the plurality of cryptographic tokens from a purchaser (Block 704). The operations 700 may further include receiving, by the token management device, the acquisition price associated with the first cryptographic token from the purchaser (Block 706). The operations 700 may further include providing, by the token management device, the first cryptographic token to the purchaser (Block 708). The operations 700 may further include providing, via a communication interface of the token management device, the sale price to the seller (Block 710).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet, or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine readable instructions that, when executed by the processor circuit, cause the processor circuit to:
display a marketplace interface at a display device comprising a plurality of cryptographic tokens, each cryptographic token comprising an acquisition price and a seller identifier associated with a seller of the cryptographic token, the acquisition price comprising a sale price;
receive a token selection of a first cryptographic token of the plurality of cryptographic tokens from a purchaser;
receive the acquisition price associated with the first cryptographic token from the purchaser;
provide the first cryptographic token to the purchaser; and
provide the sale price to the seller.

2. The system of claim 1, wherein the acquisition price associated with the first cryptographic token comprises a second cryptographic token associated with purchaser.

3. The system of claim 2, wherein provision of the sale price comprises modification of the second cryptographic token to reduce a token value of the second cryptographic token.

4. The system of claim 1, wherein the instructions that provide the first cryptographic token further cause the processor circuit to:
receive the first cryptographic token from the seller;
modify the first cryptographic token to reduce a token value of the first cryptographic token; and
provide the modified first cryptographic token to the purchaser.

5. The system of claim 1, wherein the seller comprises a first gaming operator, and
wherein the purchaser comprises a second gaming operator.

6. The system of claim 5, wherein the first gaming operator comprises a first casino operator, and
wherein the second gaming operator comprises a second casino operator.

7. The system of claim 5, wherein the first gaming operator is associated with a first gaming channel, and
wherein the second gaming operator is associated with a second gaming channel different from first gaming channel.

8. The system of claim 1, wherein provision of the sale price to the seller comprises retention of a transaction fee comprising a difference between the acquisition price and the sale price.

9. The system of claim 1, wherein the acquisition price is determined by a plurality of auction bids by a plurality of bidders, wherein a first bidder associated with a highest auction bid of the plurality of auction bids comprises the purchaser.

10. The system of claim 1, wherein the instructions further cause the processor circuit to:
determine a token identifier for a third cryptographic token associated with a token redemption request by a user;
determine a non-monetary token value for the third cryptographic token;
based on the non-monetary token value, display, at a display device, a plurality of available non-monetary awards;
receive a selection of a non-monetary award of the plurality of available non-monetary awards from the user; and
provide the selected non-monetary award to the user.

11. The system of claim 10, wherein each non-monetary award of the plurality of available non-monetary awards comprises a value equal to or less than the non-monetary token value.

12. The system of claim 10, wherein the non-monetary token value is based on game play by a player associated with the third cryptographic token.

13. The system of claim 10, wherein the non-monetary token value is based on a player status of a player associated with the third cryptographic token.

14. A token management device comprising:
a display device;
an input device;
a processor circuit; and
a memory comprising machine readable instructions that, when executed by the processor circuit, cause the processor circuit to:
display a marketplace interface at the display device comprising a plurality of cryptographic tokens, each cryptographic token comprising an acquisition price and a seller identifier associated with a seller of the cryptographic token, the acquisition price comprising a sale price;
receive, via the input device, a token selection of a first cryptographic token of the plurality of cryptographic tokens from a purchaser;
receive the acquisition price associated with the first cryptographic token from the purchaser;
provide the first cryptographic token to the purchaser; and
provide the sale price to the seller.

15. The token management device of claim 14, wherein the acquisition price associated with the first cryptographic token comprises a second cryptographic token associated with purchaser.

16. The token management device of claim 15, wherein provision of the sale price comprises modification of the second cryptographic token to reduce a token value of the second cryptographic token.

17. The token management device of claim 14, wherein the instructions that provide the first cryptographic token further cause the processor circuit to:
receive the first cryptographic token from the seller;
modify the first cryptographic token to reduce a token value of the first cryptographic token; and
provide the modified first cryptographic token to the purchaser.

18. The token management device of claim 14, wherein the seller comprises a first gaming operator, and
wherein the purchaser comprises a second gaming operator.

19. A method comprising:
displaying, by a display device of a token management device, a marketplace interface at the display device comprising a plurality of cryptographic tokens, each cryptographic token comprising an acquisition price and a seller identifier associated with a seller of the cryptographic token, the acquisition price comprising a sale price;
receiving, via an input device, a token selection of a first cryptographic token of the plurality of cryptographic tokens from a purchaser;
receiving, by the token management device, the acquisition price associated with the first cryptographic token from the purchaser;
providing, by the token management device, the first cryptographic token to the purchaser; and
providing, via a communication interface of the token management device, the sale price to the seller.

20. The method of claim 19, wherein the acquisition price associated with the first cryptographic token comprises a second cryptographic token associated with purchaser.
